(19) United States
(12) Patent Application Publication
(10) Pub. No.: US 2009/0204355 A1
(43) Pub. Date: Aug. 13, 2009

(54) METHODS AND APPARATUS FOR MODAL PARAMETER ESTIMATION

(75) Inventor: Havard I. Vold, Aldie, VA (US)

Correspondence Address: INGRASSIA FISHER & LORENZ, P.C., 7010 E. COCHISE ROAD, SCOTTSDALE, AZ, 85253, US

(73) Assignee: ATA ENGINEERING, INC., San Diego, CA (US)

(21) Appl. No.: 12/306,252

(22) PCT Filed: Jun. 27, 2006
(86) PCT No.: PCT/US06/25218

§ 371 Date: Dec. 22, 2008

(51) Int. Cl. G06F 19/00

(52) U.S. Cl. 702/108

(57) ABSTRACT

In accordance with one embodiment of the present invention, a system for extracting modal parameters of a structure includes an analysis module configured to estimate the modal parameters by computing only a subset of the autospectral matrix of the input data and then solving for the adjoint solution to extract a matrix denominator polynomial. In accordance with another aspect of the invention, orthogonal polynomials are used for the instrumental variables to estimate the matrix polynomial from which the modal parameters are extracted.

### CROSS-REFERENCE

The present application claims priority to International Application No. PCT/US2006/025218, filed on 27 Jun. 2006.

### FIELD OF THE INVENTION

The present invention generally relates to structural dynamics analysis and, more particularly, to systems and methods for extracting modal parameters of a structure.

### BACKGROUND OF THE INVENTION

In the field of structural dynamics analysis, it is often necessary to determine the set of structural resonances, or modal parameters, of a given test structure. While a typical test structure will, in theory, have an infinite number of discrete resonances, within the frequency range of interest there are a finite set of resonances that need to be identified.

Estimation of modal parameters is typically performed by applying excitation signals to various locations on a test structure while receiving response signals—e.g., displacement, force, and/or acceleration—at a number of measurement locations, some of which may correspond to the excitation locations. The resulting data is then analyzed to extract the desired set of modal parameters.

Methods for estimating modal parameters are typically split into the categories of broadband methods and sinusoidal methods (“normal mode” methods). Broadband methods (e.g., the polyreference complex exponential algorithm) analyze data where the excitation is distributed and is not restricted to a small number of frequencies. In contrast, sinusoidal methods analyze data acquired with sinusoidal excitation at fixed frequencies with one or more actuators.

Present day techniques for estimating modal parameters are unsatisfactory in a number of respects. For example, as the number of excitation signals and response signals increase, the computational complexity of current methods increases greatly. This results in a lack of efficiency and is accompanied increased processor and memory requirements. Furthermore, currently known methods require a great deal of operator intervention. In addition, current methods are subject to frequency aliasing problems.

Accordingly, it is desirable to provide more efficient methods for estimating modal parameters of a test structure. Other desirable features and characteristics of the present invention will become apparent from the subsequent detailed description of the invention and the appended claims, taken in conjunction with the accompanying drawings and this background of the invention.

### BRIEF SUMMARY OF THE INVENTION

In accordance with one embodiment of the present invention, a system for extracting modal parameters of a structure includes an analysis module configured to estimate the modal parameters by computing only a subset of an autospectral matrix of the input data and then solving for an adjoint solution to extract a matrix denominator polynomial. In accordance with another aspect of the invention, a set of orthogonal polynomials are used for the instrumental variables to estimate a matrix polynomial from which the modal parameters are extracted.

### BRIEF DESCRIPTION OF THE DRAWINGS

The present invention will hereinafter be described in conjunction with the following drawing figures, wherein like numerals denote like elements, and

FIG. 1 is a conceptual diagram of an exemplary test system in which the present invention may be employed;

FIG. 2 is a flowchart depicting a method in accordance with one embodiment of the invention; and

FIG. 3 is a flowchart depicting a method of extracting global modal parameters in accordance with one embodiment of the invention.

### DETAILED DESCRIPTION OF THE INVENTION

The following detailed description of the invention is merely exemplary in nature and is not intended to limit the invention or the application and uses of the invention. Further, there is no intention to be bound by any theory presented in any part of this document. For the sake of brevity, conventional techniques related to data transmission, signaling, network control, catalytic processes, and process control may not be described in detail herein.

The various illustrative blocks, modules, circuits, and processing logic described in connection with the embodiments disclosed herein may be implemented in hardware, computer software, firmware, or any practical combination thereof. To clearly illustrate this interchangeability and compatibility of hardware, firmware, and software, various illustrative components, blocks, modules, circuits, and steps have been described above generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the present invention.

The connecting lines shown in the various figures contained herein are intended to represent example functional relationships and/or physical couplings between the various elements. It should be noted that many alternative or additional functional relationships or physical connections may be present in a practical embodiment.

The present invention relates to modal parameter estimation (alternatively referred to as “model parameter extraction” or simply “curve fitting”), which relates to the extraction of modal parameter information from recorded response and excitation data associated with a test structure. Modal parameter estimation is used, for example, when one wants to extract a partial structural dynamics model in terms of quantities such as eigenvectors, resonant frequencies, damping, and modal mass from test data acquired from a continuum elastic body under certain boundary conditions and excitations.

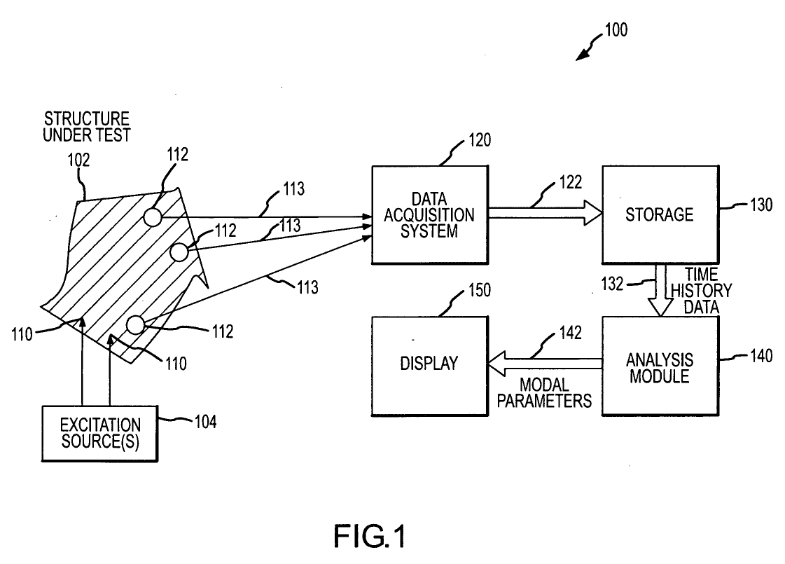

Referring to FIG. 1, a test system 100 generally comprises a data acquisition system 100, a storage subsystem (or simply “storage”) 130, an analysis module 140, and a display 150. A number of excitation sources 104 are applied to various points (or “locations”) 110 on a structure under test (“test structure” or “structure”) 102. Test structure 102 is normally fixed with prescribed boundary conditions, which can range from totally free to bolted and/or welded to an reference ground structure. Boundary conditions and vibration properties of the test structure will generally remain unchanged during a test (referred to as “stationarity”). “Excitation” as used with respect to excitation sources 104 refers to time-varying forces applied to test structure 102 to make it vibrate and to excite resonance that are to be determined. Excitation sources 104 might include, for example, various “shakers,” impact hammers, and the like.

A number of sensors and/or transducers (collectively referred to as “transducers”) 112 produce measurements regarding a physical characteristic of structure 102 at corresponding test points. Measurements are preferably made at the points of force application and at locations where acceleration, velocity, and/or displacement responses are desired. The transducers 112 produce respective signals 113, which are collected and processed by data acquisition system 120. The signals received from the transducers are processed by system 120 through analog circuitry and converted to digital information at a predefined sampling rate.

The acquired data 122 is sent to and stored by a suitable storage component 130 (e.g., disc storage, non-volatile memory, or the like), and then sent, in the form of time history data 132, to an analysis module 140—the operation of which is described in further detail below. Modal parameters 142 determined by analysis module 140 may then be presented to the user in a variety of forms. In one embodiment, for example, modal parameters 142 are displayed graphically on a display (e.g., conventional computer monitor) 150, in a quantitative and/or qualitative manner.

In general, then, a modal test is performed on structure 102 via excitation sources 104 and transducers 112, and the results of that test are used by analysis module 140 to estimate modal parameters 142. The purpose of the modal test is thus to estimate a set of parameters that describe a target set of structural resonances.

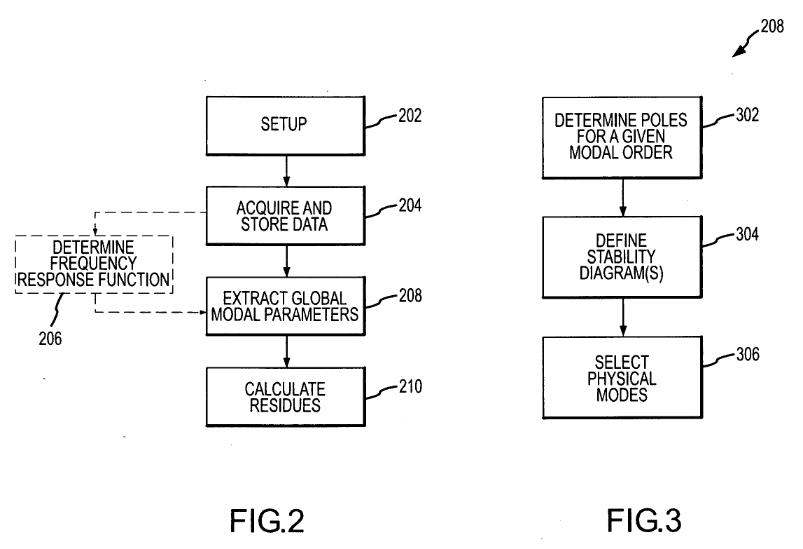

FIG. 2 is a flowchart depicting, at a high level, a model estimation method in accordance with one embodiment of the present invention. As shown, the process begins with setup step 202, wherein the test structure 102 is connected to, coupled to, or otherwise configured to interface with appropriate excitation sources 104 and transducers 112. Suitable boundary conditions for structure 102 are also applied. Those skilled in the art will understand the manner in which test structures are typically set up for testing.

Next, in step 204 data is acquired and stored (e.g., via data acquisition system 120 and storage 130 in FIG. 1) using the an appropriate testing procedure. The duration and characteristics of this procedure will generally vary depending upon the nature of test structure 102, as is known in the art.

Next, in steps 208 and 210, the system (e.g., analysis module 140 in FIG. 1) extracts global modal parameters, and calculates residues. In this regard, while any continuum test structure 102 has a countable infinity of resonances, within a finite frequency range there are a finite number of resonances that need to be identified. The term “modal parameters” is generally used to describe a resonance (or “mode”) with all of its attendant parameters, wherein these parameters generally include global parameters, force parameters, and local parameters.

Global parameters are global to the structure 102—i.e., they apply to structure 102 as a whole. Such parameters might be called modes, poles, or roots, but each contain information related to frequency and damping. With respect to frequency, each resonance has a given time to complete a full cycle, which is called the period of the resonance. The inverse of the resonance is called the frequency, and is normally expressed in Hertz (cycles per second). With respect to damping, without external excitation, energy in a test structure will be dissipated by a resonance at a rate referred to as the damping rate, which may be expressed in Hertz, or in percentage of critical damping. In contrast to global parameters, force parameters relate to a modal participation factor (MPF), which is a left eigenvector in the force measurement locations only. Force parameters are discussed more fully below.

Local parameters relate to the characteristics of each mode at each measured location of the test structure, and include mode shape (or “residue”). The mode shape is the physical response (in terms of a vector comprising three translations and three rotations) to a given force measurement, characterized by an acceleration response in each global mode at each measured response location.

A “time history” (such as time history data 132 received by analysis module 140) is a scalar function of time and describes a physical quantity that changes with time, such as acceleration, velocity, displacement, and the like. A “vector time history,” on the other hand, is a vector-valued function of time, typically comprised of individual scalar time histories. A “continuous time history” is a time history for which the values are known in a continuum segment of time, finite or infinite. A “discrete time history” is one in which the values are known at discrete instances of time, and comprise a finite or countably infinite set of time points.

A “bounded spectrum” means that a time history has only energy within a finite segment of the infinite frequency range. A “free decay” is a time history that describes the response of a structure while there is no external excitation applied—i.e., the segment of a unit response that occurs after the input impact has ended.

As is known in the art, according to Shannon's Sampling Theorem, a continuous time history with a bounded spectrum can be represented by a discrete sampled time history without loss of information when the sampling rate is higher than twice the highest frequency of the bounded spectrum. This means that a continuous time history with a bounded spectrum can be reconstructed with any desired accuracy from a discrete counterpart if the sampling rate meets this criterion.

As shown in FIG. 2, the system may optionally determine the frequency response function of the stored data (step 206). As is known in the art, a frequency response function (FRF) is a function of frequency that gives the structural response at a given location to a unit force input at another location. A unit input response is a time history that corresponds to the structural response at a given location to a unit impact force input at another location. This is alternatively referred to as the inverse Fourier transformation of an FRF.

Residue calculation (step 210) may be performed through a variety of well-known procedures, wherein knowledge of the poles makes the resulting unknown mode shapes occur in a linear fashion.

Referring now to FIG. 3, the step of extracting global modal parameters (step 208) may be divided into a number of sequential operations. First, in step 302, the poles for a given model order are determined. That is, force input time histories and response output time histories are processed to give a matrix polynomial whose eigensolution provides the complex poles, which defines the frequency and damping of the modes within a desired frequency range.

Next, in step 302, suitable stability diagrams are defined. This step involves finding physical quantities that are independent of the procedures used to determine their values. It follows that if one computes the values by different models, there will be a tendency for the real underlying parameters to stay stable from one model order to the next, whereas purely computational artifacts will behave erratically. Hence, the permanence and persistence of estimated values can be used as a criterion for determining which values are real.

Finally, in step 306, physical modes are selected. That is, through automated procedures and/or manual selection with the aid of tables of candidate modal parameters and the stability diagrams, poles that are deemed to be both physically meaningful and significant for the purpose of the modal analysis are selected.

Having thus given an overview of a system in accordance with the present invention, a more detailed description of the mathematical underpinnings of the method will now be described. In accordance with one aspect of the present invention, a subset of the system autospectral matrix polynomial is computed, and the adjoint system is used to extract the denominator matrix polynomial to solve for high modal density and repeated poles. In accordance with another aspect of the present invention, orthogonal polynomials are used for the instrumental variables to estimate the matrix polynomial.

While not limiting, the description that follows is restricted to situations where the structure and its boundary conditions may be regarded as time invariant and linear in with respect to properties. Under these assumptions, linear, time invariant viscously-damped continuum structures have an infinite and discrete set of resonant frequencies, such that any bounded frequency range contains a finite number of resonant frequencies. Thus, the task of the modal parameter extraction method is to provide a mathematical model of the resonances in a bounded frequency range from data (i.e., time history data 132) acquired at a finite number of points in the continuum of test structure 102.

For the purpose of this description, and without loss of generality, it is assumed that the time histories of the various forces, accelerations, etc. have been filtered by analog means such that the power spectrum of the measured time histories are bounded, and that the sampling rate during digitization is higher than the Nyquist frequency, which is given by the sampling theorem, such that there is no aliasing in the sampled digital data.

Absence of aliasing means that the sampled data is sufficient to recreate the continuous bounded spectrum analog time histories to any desired accuracy. It is further assumed that the excitation applied to the structure (via excitation sources 104) as well as the measured response (113) start at a level below the ambient noise floor, and that the excitation and response also drop below the noise floor at the end of the measurement time interval. A mollifier function (e.g., a Hanning window) may be applied to approximate or enforce this condition. The boundedness in spectrum and time together with a sample rate higher than the Nyquist frequency ensures that the finite digital data set retains sufficient information to reconstruct the continuous time data and that the finite discrete Fourier transform may be used to calculate the infinite continuous time Fourier transform.

It is further assumed, for the purpose of this description, that the center of the frequency range of interest is frequency-shifted (also referred to as “frequency zooming” or “heterodyning”) down to the zero frequency and low-pass filtered such that that the resulting vector time history is complex and analytic. The term “analytic” as used herein is consistent with its use in the context of signal processing—i.e., related to causality and minimum phase considerations.

A mathematical formulation in accordance with the present invention will now be described. Without loss of generality, and for the purposes of conciseness, it is assumed that only forces and accelerations are measured. It will be appreciated, however, that any number of other measurements may be made through any number of transducers and sensors.

When a linear elastic continuum structure is projected down to a finite set of force input reference freedoms and a finite set of acceleration response freedoms, the corresponding Laplace domain transfer function H_{∞}(s) can be written in resolvent form as:

H_{∞}(s)=V_{∞}(Is−Λ_{∞})⁻¹V_{∞f}^{H}, (1)

where Λ_{∞} is the infinite diagonal matrix of eigenvalues, V_{∞} is the infinite matrix of left eigenvectors at the response freedoms, and V_{∞f} is the infinite matrix of right eigenvectors at the reference freedoms. It is assumed that the frequency range has been shifted to center the positive bounded frequency interval of interest. The continuum spectrum is then partitioned into three families: one for frequencies smaller than all analysis frequencies, one for frequencies higher than all analysis frequencies, and one for frequencies within the analysis interval.

Thus, the transfer function is split in three parts, of which the H(s) term, belonging to the analysis interval, is seen to consist of a finite number of terms:

H_{∞}(s)=H_{∞}(s)+H(s)+H_{∞}(s) (2)

H_{∞}(s)=V_{∞}(Is−Λ_{∞})⁻¹V_{∞}f^{H}

H_{∞}(s)=V_{∞}(Is−Λ)⁻¹V_{f}^{H} (3)

H_{∞}(s)=V_{∞}(Is−Λ_{∞})⁻¹V_{∞f}^{H}

Bandpass filtering the time histories over the analysis band removes all power outside the band, but the system is still measuring the H_{∞}(s) transfer function, which contains contributions from the infinite discrete spectrum of the continuum. While these contributions may be small, they often obscure important information from the resonant frequencies within the analysis interval, especially damping information.

The analysis range contains a finite spectrum of the continuum, so by neglecting the effect of the spectrum outside this range, there will be a complex matrix polynomial A(•) in the temporal differentiation operator d•/dt such that:

$$A ( \frac{d \cdot }{d t} ) Y ( t ) = ɛ ( t ) , \qquad ( 4 )$$

where Y(t) is the complete vector of force and acceleration time histories, and ε(t) is restricted to a causal purely nondeterministic error process, including unmeasured excitation sources. Since the analytic signal Y(t) is band-limited, it can be differentiated as much as desired. Applying the infinite continuous Fourier transform, equation (4) above becomes:

A(ω)Y(ω)=ε(ω), (5)

Since the data has a bounded spectrum, the function c₊(.) can be defined such that it takes the value 1 within the analysis interval and zero everywhere else. This allows equation (5) to be rewritten as (c₊(ω)A(ω))Y(ω)=ε(ω), or by denoting c₊(ω)A(ω) as A|(ω), as:

A|(ω)Y(ω)=ε(ω), (6)

where it can be seen that since A|(ω) has bounded support, it is Fourier-invertible to an infinitely differentiable matrix function in a real variable. Thus, equation (4) may be written in a convolution form as:

∫_{-∞}^{∞}A|(ω)Y(t−ω)dω=ε(t), (7)

where it is seen that the differential operator polynomial has been transmogrified into the inverse of a Green's function, since the data has a bounded spectrum.

It will be appreciated that there are alternate bases for the matrix polynomial. That is, numerical computation with power polynomials tends to be difficult from a numerical accuracy point of view when the polynomial order exceeds five or six, even with multiple precision arithmetic. Orthogonal polynomials have been introduced for approximation and curve fitting, and are able to increase the highest polynomial orders that can be used. Such schemes, however, are still limited to single-digit orders in modal parameter estimation work. It has been shown that the primary problem in ill-conditioning using orthogonal polynomials lies in the process of transforming back to power polynomial coefficients to solve for the zeros of the polynomials. A solution to this problem is to devise a means for finding roots within the orthogonal polynomial coordinate system, which the present inventor pioneered, in part, through the introduction of a generalized polynomial companion matrix, which completely removes the numerical limitations of high polynomial order.

Consider sets of polynomials pᵣ(z), zεC for integer r≧0, such that pᵣ(z) is a polynomial of order r, and there exist coefficients such that:

$${P}_{r + 1} ( z ) = z {d}_{r} {p}_{r} ( z ) + {\sum }_{k = 0}^{r} {l}_{rk} {p}_{k} ( z ) . \qquad ( 8 )$$

It follows that there is a possibly infinite diagonal matrix D and a corresponding lower triangular matrix L such that:

$$( \begin{matrix}{p}_{1} ( z ) \\ {p}_{2} ( z ) \\ ⋮ \\ {p}_{k} ( z ) \\ ⋮\end{matrix} ) = ( z D + L ) ( \begin{matrix}{p}_{0} ( z ) \\ {p}_{1} ( z ) \\ ⋮ \\ {p}_{k - 1} ( z ) \\ ⋮\end{matrix} ) . \qquad ( 9 )$$

Equation (9) can be used to construct a generalized companion matrix to solve for the resonances within the analysis frequency band. In this description, orthogonal polynomials are used relative to some unspecified inner product, which normally would be defined through some collocation scheme along the frequency axis of interest. A weighted set of Forsythe polynomials are normally used over the analysis band as the basis for the numerical work in this description.

The error process will now be given more structure in order to sharpen the applicability of the following procedures. The method allows for the situation when some or all of the excitation inputs (excitation sources 104) are not measured. Under certain weak assumptions, the system will still be able to estimate modal parameters, sometimes even modal mass. In this regard, a necessary but insufficient condition for modal mass estimation is that a sufficient spectrum of excitation forces have been measured.

It is assumed that the error time history is a purely indeterministic process, such that any deterministic part, e.g., sine waves, will be measured and placed into the autoregressive part. This decomposition of a stationary stochastic process into a purely deterministic part and a causal, purely indeterministic part is an element of the well-known Wold decomposition. The error process ε(t) shall be a causal, stationary process derived from a white noise process η(t) by an analog filter with a finite number of poles and zeros such that the governing equation is:

$${\sum }_{k = 0}^{{k}_{1}} {α}_{{k}_{1} - k} ( \frac{{d}^{k}}{d {t}^{k}} ) ɛ ( t ) = {\sum }_{k = 0}^{{k}_{2}} {β}_{{k}_{2} - k} ( \frac{{d}^{k}}{d {t}^{k}} ) η ( t ) , \qquad ( 10 )$$

which in the frequency domain reads:

$$\begin{matrix}ɛ ( t ) = \frac{{\sum }_{k = 0}^{{k}_{2}} {β}_{{k}_{2} - k} {ω}^{k}}{{\sum }_{k = 0}^{{k}_{1}} {α}_{{k}_{1} - k} {ω}^{k}} η ( ω ) \\ = \frac{β ( ω )}{α ( ω} η ( ω ) ,\end{matrix} \qquad ( 11 )$$

such that the denominator polynomial may be multiplied into A|(ω) in equation (6) to give the form:

α(ω)A|(ω)Y(ω)=β(ω)η(ω) (12)

It can be seen that the α(•) polynomial in equation (12) simply adds more computational poles into the autoregressive part. Filtering off computational poles is a process in the later stages of system identification, so they can be taken along, so that the equation with a finite moving average noise excitation becomes:

Ã(ω)Y(ω)=β(ω)η(ω) (13)

where Ã(•) has the same functional form as the operator polynomial A(•) in equation (4). The tilde can be dropped hereinafter, thus reverting to the continuous time domain whereby equation (13) is equivalent to:

$$A ( \frac{d }{d t} ) Y ( t ) = β ( \frac{d }{d t} ) η ( t ) . \qquad ( 14 )$$

Estimation of the coefficients of the matrix polynomial A(•) in equation (13) may be done using the traditional least squares procedure by demanding that the estimation error be uncorrelated with a set of instrumental variables derived from the measured time history. Such instrumental variables should be correlated with the structural response, but uncorrelated with the estimation error. This set of instrumental variables can be constructed as Iₖ(t), kε[0 . . . 1) by applying to the measured time history a differential operator based on orthogonal polynomials chosen for the numerical computations—i.e.:

$${I}_{k} ( t ) = {p}_{k} ( \frac{d }{d t} ) Y ( t ) , \qquad ( 15 )$$

where pₖ(•) is the orthogonal polynomial of order k. Two correlation functions G(k, u) and e(k, u) can be defined by:

G(k,u)=E(Y(t)Iₖ^{H}(t−u)) (16)

e(k,u)=E(ε(t)Iₖ^{H}(t−u)) (17)

First, it can be seen that, because the processes are assumed stationary, the correlation functions are independent of the time variable t. Second, because the error process is causal and the system is at rest before time zero, e(k, u)=0 for u≠0.

The estimation procedure then consists of first determining a range K for the polynomial order k, for which e(k, 0)≡0, for all kεK. A side condition is added that A(•) be a monic matrix polynomial in order to normalize equation (14), even though a Total Least Squares (TLS) solution, based on singular value decompositions, would also be a candidate normalization scheme.

The next step involves moving to the frequency domain and using orthogonal polynomials. First, equation (14) is transformed by postmultiplying with the Hermitian transpose of the instrumental variables, taking expectations and applying the infinite continuous Fourier transform:

$$E ( A ( \frac{d }{d t} ) Y ( t ) {( {p}_{k} ( \frac{d }{d t} ) Y ( t - u ) )}^{H} ) = E ( β ( \frac{d }{d t} ) η ( t ) {( {p}_{k} ( \frac{d }{d t} ) Y ( t - u ) )}^{H} ) , \qquad ( 18 )$$

which reduces to:

A(ω)G(k,ω)=β(ω) ν̅(̅ω̅)̅σ, (19)

where σ, the covariance between noise and signal at the same instant of time, is unknown but independent of frequency. Note that, since the data has a bounded spectrum, one may freely transform between the frequency domain and the continuous time domain with no information loss. Next, the matrix polynomial A(•) is expressed in the polynomial basis as:

$$A ( z ) = {\sum }_{j = 0}^{n} {A}_{n - j} {p}_{j} ( z ) , {A}_{0} = I , \qquad ( 20 )$$

where n denotes the order of the polynomial, and:

$$β ( z ) = {\sum }_{j = 0}^{{k}_{2}} {β}_{{k}_{2} - j} {z}^{j} , \qquad ( 21 )$$

where k₂ is the moving average size. Next, the inner product intrinsic to the definition of the orthogonal polynomials is applied to (19) such that:

$$〈 A ( \cdot ) , G ( k , \cdot ) 〉 = σ {\sum }_{j = 0}^{{k}_{2}} {β}_{{k}_{2} - j} 〈 {z}^{j} , {p}_{k} ( z ) 〉 , \qquad ( 22 )$$

and since the polynomial pₖ(•) is orthogonal to all polynomials of lesser order, this means that:

∀k>k₂{A(>),G(k,)}=0, (23)

or, equivalently, that the range K, for which e(k, 0)=0, is given by K={k|k>k₂} The instrumental variables Iₖ(•) then are uncorrelated with the error when the orthogonal polynomial order k is larger that the number of moving average terms in the error numerator. If the error was uncorrelated with the signal in the first place, there are no restrictions on the order k.

The next step involves estimation in the general case. When e(k, u)=0 for all kεK, equation (23) with the help of (20) can be written as:

$${\sum }_{j = 0}^{n} {A}_{n - j} 〈 {p}_{j} ( \cdot ) , G ( k , \cdot ) 〉 = 0 , k ∈ K . \qquad ( 24 )$$

Define the matrix of polynomial coefficients as:

Ā=[Aₒ A . . . |. . . Aₒ], (25)

and the data matrix Pⱼ of all the Fourier transformed measurements Y(ω) and polynomial bases evaluated at ω for each discrete ω in the analysis band as:

$${P}_{j} = [ \begin{matrix}… & ( \begin{matrix}{p}_{j} ( ω ) \\ {p}_{j + 1} ( ω ) \\ ⋮ \\ {p}_{j + n} ( ω )\end{matrix} ) ⊗ Y ( ω ) & …\end{matrix} ] , \qquad ( 26 )$$

where [symbol] denotes the tensor or Kronecker product. Equation (24) is now equivalent to:

ĀPⱼPₖ^{H}=0,∀kεK; (27)

Normally, the smallest possible k would be chosen. A monic estimate of the matrix polynomial coefficients may be obtained through the condition that A₀=I and solving equation (27) directly, or by application of a TLS procedure. In the special case where the error is uncorrelated with the signal, k (the polynomial order) can be set to zero, in which case the coefficient matrix of equation (27) is a positive semidefinite Hermitian matrix, such that either a Cholesky decomposition or a QR triangularization may be used for the solution.

The next step involves deriving a practical estimation of the characteristic matrix polynomial. This section addresses the desirability of fast and accurate computation, and is inspired by the Betti-Maxwell Reciprocity Theorem, which states that, for a linear stationary structure, input at one location and response at another location will stay the same when the roles of exciter and response sensing are reversed. In this regard, the present invention exploits the fact that the system that is being identified is either self-adjoint and has reciprocity, or its dual or adjoint system possesses the same eigenvalues as the original system. Start by partitioning the homogenous form of equation (13) into response and force coordinates to obtain:

$$A ( ω ) Y ( ω ) = [ \begin{matrix}{A}_{XX} ( ω ) & {A}_{XF} ( ω ) \\ {A}_{FX} ( ω ) & {A}_{FF} ( ω )\end{matrix} ] ( \begin{matrix}X ( ω ) \\ F ( ω )\end{matrix} ) . \qquad ( 28 )$$

Expanding the top equation of (28) gives a rational matrix transfer function form for the response in terms of the measured forces by:

$$\begin{matrix}\begin{matrix}X ( ω ) = - {A}_{XX}^{- 1} ( ω ) {A}_{XF} ( ω ) F ( ω ) \\ = {H}_{X} ( ω ) F ( ω ) ,\end{matrix} & ( 29 )\end{matrix}$$

where X(ω) is response, F(ω) is force, and H(ω) is shorthand for the transfer function matrix. The system poles are the complex numbers z, for which H_{X}(•) has a pole, or equivalently, those eigenvalues z for which there exist an eigenvector V_{z} satisfying

A_{XX}(x)V_{z}=0 (30)

In equation (29), it is seen that the denominator matrix polynomial is a square matrix the size of the number of response channels, and it can also be shown that the memory and compute requirements for solving equation (27) may be quite overwhelming for measurements with a large number of responses. This may make it impractical to solve for the denominator polynomial A_{XX}(ω) in the response freedoms in order to find the system poles.

The next step involves looking at the adjoint system by examining a single response channel and all the measured force channels, and, revisiting equation (28), expanding the second equation into:

$$\begin{matrix}\begin{matrix}F ( ω ) = - {A}_{FF}^{- 1} ( ω ) {A}_{FX} ( ω ) X ( ω ) \\ = {H}_{F} ( ω ) X ( ω ) ,\end{matrix} & ( 31 )\end{matrix}$$

which relates all the forces to a single response. If the structure now satisfies the Betti-Maxwell Reciprocity Theorem, the roles of force and response can be interchanged, such that the equation:

\hat{X}(ω)=H_{F}(ω)\hat{F}(ω) (32)

is a valid expression for the response vector \hat{X}(ω) at the force measurement points given the force scalar \hat{F}(ω) at the original response measurement point. It follows that the system poles are those complex values of z for which H_{F}(ω) has a pole, or just as in (30) that there exists a eigenvector \hat{V}_{Z} and an eigenvalue z for which:

A_{FF}(z)\hat{V}_{Z}=0 (33)

In normal modal testing situations, the number of force measurement points might be less than approximately ten, whereas the number of response measurements might be many hundreds. Since system poles are global properties, theoretically those modes which can be excited from the force location in equation (31), or observed from the response locations in the same equation, would correspond to solutions of equation (33).

The eigenvector coefficients in the response locations would be given by the eigenvectors \hat{V}_{Z} in that equation. Now consider the case in which the reciprocity theorem does not apply—for example, when the system hides a running momentum wheel, which due to Coriolis forces will act in an unusual manner which does not dissipate energy, but which adds an antisymmetric velocity component. The interchange of force and response cannot be interpreted literally anymore, but the eigenvalues of equation (31) are still the system poles and the eigenvectors \hat{V}_{Z} must be considered the left or dual eigenvectors of the structure. These left eigenvectors of equation (33) are also called the “modal participation vectors.” One may use this more general case at the negligible intellectual expense of having to distinguish between left and right eigenvectors.

The next step involves solving sequentially for each response channel. Since equation (33) for a single generic response channel x is insufficient to define the mode shapes for the complete structure, and since there will normally be some modes which are not observable or controllable from that location, a sequential procedure can be developed to accumulate information from all response points into the estimate for the denominator matrix polynomial A_{FF}(z) at the force locations. The columns of the matrix of polynomial coefficients (25) are first permuted so that all the response labeled columns precede the force labeled columns—i.e. there exists a permutation matrix Q, such that:

AQ=A=[AₓA_{F}], (34)

which induces the partitioning on the matrix Pⱼ of equation (26):

$$\begin{matrix}\begin{matrix}{Q}^{H} {P}_{j} = {P}_{j} \\ = [ \begin{matrix}{P}_{jx} \\ {P}_{jF}\end{matrix} ] \\ = [ \begin{matrix}… & ST ( j , n , p \cdot ( \cdot ) , ω ) ⊗ x ( ω ) & … \\ … & ST ( j , n , p \cdot ( \cdot ) , ω ) ⊗ F ( ω ) & …\end{matrix} ] ,\end{matrix} & ( 35 )\end{matrix}$$

where:

$$ST ( j , n , p . ( \cdot ) , ω ) = ( \begin{matrix}{p}_{j} ( ω ) \\ {p}_{j + 1} ( ω ) \\ ⋮ \\ {p}_{j + n} ( ω )\end{matrix} ) . \qquad ( 36 )$$

with this partitioning, equation 27 can be rewritten as:

AP₀P_{w}^{H}=0 (37)

or:

$$\begin{matrix}[ \begin{matrix}{A}_{x} & {A}_{F}\end{matrix} ] & [ \begin{matrix}{P}_{0 x} {P}_{jx}^{H} & {P}_{0 x} {P}_{jF}^{H} \\ {P}_{0 F} {P}_{jx}^{H} & {P}_{0 F} {P}_{jF}^{H}\end{matrix} ] = 0.\end{matrix} \qquad ( 38 )$$

Given the response coefficients defined by the first column of equation (38), the response term can be eliminated from the second column to obtain:

Aᵥ(V_{w}F_{w}^{k-P}₀ₓV_{jF}^{v}(P₀ₓVⱼₓ^{v})⁻¹P_{0F}vⱼₓ^{k})=0, (39)

which is a set of constraints on A_{F} induced by the generic response channel x. Denoting the set of all response channels X, a least squares set of constraints can be imposed on the force coefficients by:

$${A}_{F} {P}_{0 F} {P}_{jF}^{H} = {A}_{F} {\sum }_{x ∈ X} {P}_{0 x} {{P}_{jF}^{H} ( {P}_{0 x} {P}_{jx}^{H} )}^{- 1} {P}_{0 F} {P}_{jx}^{H} . \qquad ( 40 )$$

Together with the requirement that the highest order coefficient should be the unit matrix, equation (40) then defines the least squares solution for the characteristic matrix polynomial in the force locations, from which the system poles, i.e., eigenvalues and left eigenvectors or modal participation vectors, can be found in a numerically stable way by the orthogonal companion matrix method described above.

It is clear from inspection of equation (40) that the computation of the system poles by using the adjoint system (or Betti-Maxwell method) is superbly efficient in both memory and computational complexity, since only one response channel and all the force channels need to be considered at any given time, and only one pass is made over the complete data set.

The next step involves solving for the eigenvalues and the modal participation factors. In one embodiment, this involves solving for the eigenvalues and modal participation vector in the orthogonal polynomial coordinate system through the generalized companion matrix equation. The numerical conditioning when using this approach is so benign that no practical limit other than compute speed exists for the number of eigenvectors that we can handle at high accuracy. The eigenproblem for the matrix polynomial A(•) expressed in the orthogonal polynomial basis from equation (8) is:

$${\sum }_{k = 0}^{n} {A}_{n - k} {p}_{k} ( z ) V = 0. \qquad ( 41 )$$

let us define:

$${V}_{j} ( z ) = ( \begin{matrix}{p}_{j} ( z ) \\ {p}_{j + 1} ( z ) \\ ⋮ \\ {p}_{j + n} ( z )\end{matrix} ) ⊗ V . \qquad ( 42 )$$

Now, using equation (9), equation (41) can be rewritten in a linearized form as:

Vₗ(z)=((zD+L) [symbol] I)V₀(z), (43)

where I is a the identity matrix of same dimension as V. Furthermore, let A₀=I and the companion matrix Ã as:

$$\tilde{A} = [ \begin{matrix}0 & I & 0 & … & 0 \\ 0 & 0 & I & … & 0 \\ ⋮ & ⋮ & ⋮ & ⋱ & ⋮ \\ & & & … & I \\ - {A}_{n} & - {A}_{n - 1} & & … & - {A}_{1}\end{matrix} ] . \qquad ( 44 )$$

Then it is clear that equation (41) can be reformulated as:

ĀVₓ(z)=Vₓ(z), (45)

and applying equation (43) to this, produces:

ĀV₀(z)=((zD+L) [symbol] l)Vₒ(x),

which can be algebraically manipulated as:

( A̅−L [symbol] I)V₀(x)=z(D [symbol] I)Vₓ(z), (46)

which is a generalized eigenproblem for the eigenvalue z and the right eigenvector V₀(z). The V segment of a V₀(z) eigenvector is called a modal participation factor. Note that equation (46) is formulated in the orthogonal polynomial coordinate system, such that no catastrophic loss of numerical accuracy is incurred, as would ensue as a result of transforming back to power polynomials in order to solve the original matrix polynomial eigenproblem (41).

The next step involves calculating the scaled eigenvectors. Here, the eigenvalues and modal participation vectors are used to write the transfer function matrix in its resolvent form, wherein it is seen that the eigenvector components occur in a linear fashion as unknowns, and hence can be solved for in a number of standard least squares or minimum norm formulations.

This was first suggested for use with the Polyreference method by Crowley et. al. in 1985 and is now a commonly-used method after the eigenvalues and modal participation factors have been determined. The outer product of the modal participation vector and the eigenvector for a given mode is called the residue matrix for that mode/pole, and is an absolute quantity. The eigenvector can be estimated as components for all eigenvalues that were extracted from the generalized companion matrix, and will then allow classification of eigenvalues as negligible or as computational roots, when the norm of the residue matrix is small, or when the residue matrix is deviating too much from monophase behavior. As is known in the art, a monophase vector is a complex valued vector for which each component is either in phase, or 180 degrees out of phase.

It can be indicated how the right eigenvectors and the residues are found, by defining Λ as the set of all eigenvalues, and {V_{λ}|λεΛ} as the set of all left eigenvectors. The measured response in the single channel x in the frequency is then given by the sum:

$$x ( ω ) = ( {\sum }_{λ ∈ Λ} {{V}_{λ} ( ω - λ )}^{- 1} {L}_{x λ} ) F ( ω ) , \qquad ( 47 )$$

where {L_{xλ}|λεΛ} is the set of the right eigenvectors at the x response location and F(ω) is the measured force vector. The right eigenvectors are found by standard least squares solutions of equation (47), and the residue matrices R_{λ} are simply:

R_{λ}=V_{λ}[. . . L_{xλ}. . . ],xεX (48)

In summary, the present invention provides systems and methods for estimating modal parameters which are advantageous in a number of respects. For example, the present method is unaffected by the aliasing problems that limit z-domain methods such as polyreference, complex exponential, polymax, ERA, and ITD. Furthermore, the numeric conditioning provided by the present invention is better than that of the previously-mentioned methods, as well as Laplace domain methods such as rational fraction orthogonal polynomial, direct parameter estimation, and ISSPA. In addition, the processor and memory requirements of the present invention are lower than or comparable to these methods, and are conducive to vector processing and parallel processing. The present methods provide efficient, consistent estimations of modal parameters, including modal mass, when only part of the exciting forces are measured.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A method of extracting modal parameters of a test structure, the method comprising:
applying a set of excitation signals to the test structure;
receiving a set of response signals from the test structure; and
estimating the modal parameters from the excitation signals and response signals, wherein the estimating includes computing a subset of an autospectral matrix from a subset of the set of excitation signals and the set response signals, and solving for an adjoint solution to extract a matrix denominator polynomial.

2. The method of claim 1, further including using orthogonal polynomials for instrumental variables to estimate the matrix denominator polynomial.

3. The method of claim 1, further including determining a frequency response function for the set of excitation signals and the set of response signals.

4. The method of claim 1, further including calculating residues for the response signals.

5. The method of claim 1, wherein estimating the modal parameters includes determining a set of poles for a given modal order, defining one or more stability diagrams, and selecting the modal parameters based on the set of poles and one or more stability diagrams.

6. The method of claim 1, further including displaying the modal parameters.

7. The method of claim 1, wherein the response signals are indicative of at least one of a force, an acceleration, a velocity, or displacement of a point on the test structure.

8. A test system for extracting modal parameters of a test structure, the system comprising:
a plurality of excitation sources configured to apply a set of excitation signals to the test structure;
a plurality of transducers coupled to the test structure and configured to receive a set of response signals from the test structure;
a data acquisition system configured to receive the set of response signals and produce a digital data set responsive thereto;
an analysis module configured to estimate the modal parameters from a subset of the excitation signals and the set of response signals by computing a subset of an autospectral matrix of the excitation signals, and solving for an adjoint solution to extract a matrix denominator polynomial.

9. The system of claim 8, wherein the analysis module uses orthogonal polynomials for instrumental variables to estimate the matrix denominator polynomial.

10. The system of claim 8, wherein the analysis module determines a frequency response function for the set of excitation signals and the set of response signals.

11. The system of claim 8, wherein the analysis module calculates residues for the response signals.

12. The system of claim 8, wherein the analysis module estimates the modal parameters by determining a set of poles for a given modal order, defining one or more stability diagrams, and selecting the modal parameters based on the set of poles and one or more stability diagrams.

13. The system of claim 8, further including a display configured to display the modal parameters.

14. The system of claim 8, wherein the plurality of transducers are configured to measure of at least one of a force, an acceleration, a velocity, or displacement of a point on the test structure.
